(19) United States
(12) Patent Application Publication
(10) Pub. No.: US 2014/0183871 A1
(43) Pub. Date: Jul. 3, 2014

(54) Wind Turbine Apparatus Powered by Wind Generated from Building Cooling and Chiller Unit

(71) Applicant: Rene Gerome Baptiste, New Orleans, LA (US)

(72) Inventor: Rene Gerome Baptiste, New Orleans, LA (US)

(21) Appl. No.: 13/731,675

(22) Filed: Dec. 31, 2012

(51) Int. Cl. F03D 9/00; F03D 3/00

(52) U.S. Cl. CPC F03D 9/002; F03D 3/005
USPC 290/55

(57) ABSTRACT

Wind turbine apparatus of two embodiments of vertical 12 and horizontal 10 structural tubing bolted together with generator 20 and blades 22, horizontally paralleling building chilling 18 and cooling unit 40, bolted into foundation surface. The structural tubing is made of weather resistant material consisting of metal, aluminum, hard plastic, or wood. Wind generated from building chilling 18 and cooling 40 units rotates blades 22 bolted onto generator 20, generating electricity for consumption, storage, and/or distribution.

### BACKGROUND

### Prior Art

The following is a tabulation of some prior art that presently appears relevant:

### U.S. Patents

| Pat. No. | Kind Code | Issue Date | Patentee |
|---|---|---|---|
| 4,012,163 | A1 | 1977-3-15 | Baumgartner |
| 5,203,672 | A1 | 1993-4-20 | Wolf |
| 0,032,954 | A1 | 2010-2-11 | Law |
| 0,209,247 | A1 | 2010-2-16 | Becker |

### Foreign Patent Documents

| Foreign Doc. Nr. | Country Code | Kind Code | Publ. Date |
|---|---|---|---|
| 343417 | JP | A | 2003-12 |
| 251270 | JP | A | 2004-9 |
| 036038 | WO | A1 | 2004-4 |

Wind turbine companies commonly use custom designed rotors and wind vanes affixed upon an alternator for energy production. These rotors and wind vanes affixed to an alternator are welded/bolted onto large vertical towers. The large vertical towers are bolted into a cement foundation outdoors creating a wind turbine system.

A wind turbine is a device that converts kinetic energy from the wind into mechanical energy. If the mechanical energy is used to produce electricity, the device may be called a wind generator or wind charger. If the mechanical energy is used to drive machinery, such as for grinding grain or pumping water, the device is called a windmill or wind pump.

Developed for over a millennium, today's wind turbines are manufactured in a range of vertical and horizontal axis types. The smallest turbines are used for applications such as battery charging or auxiliary power on sailing boats; while large grid-connected arrays of turbines are becoming an increasingly large source of commercial electric power.

Wind turbines are designed to exploit the wind energy that exists at a location. Aerodynamic modeling is used to determine the optimum tower height, control systems, number of blades and blade shape. Wind turbines can be divided into three components:
1. The rotor component, which includes the blades for converting wind energy to low speed rotational energy.
2. The generator component, which includes the electrical generator, the control electronics, and most likely a gearbox (e.g. planetary gearbox, adjustable-speed drive or continuously variable transmission) component for converting the low speed incoming rotation to high speed rotation suitable for generating electricity.
3. The structural support component, which includes the tower and rotor yaw mechanism.

A 1.5 Mega Watt (MW) wind turbine of a type frequently seen in the United States has a tower 50-80 meters high. The rotor assembly (blades and hub) weighs 48,000 pounds (22,000 kg). The nacelle, which contains the generator component, weighs 115,000 pounds (52,000 kg). The concrete base for the tower is constructed using 58,000 pounds (26,000 kg) of reinforcing steel and contains 250 cubic yards (190 cubic meters) of concrete. The base is 50 feet (15 m) in diameter and 8 feet (2.4 m) thick near the center.

Although Mega Watt wind turbines generate large amounts of electricity, can be located on land and in water, and has proven to be an effective system, nevertheless they simply do not possess the flexibility for urban inner city home and commercial usage, they are expensive and need large machines for delivery of essential components and installation, and is intermittent in nature as it generates energy only when the wind blows. These systems also entail large amounts of land for use.

Smaller wind turbine systems function better within smaller areas. The US Department of Energy's National Renewable Energy Laboratory (NREL) defines small wind turbines as those smaller than or equal to 100 kilowatts. Small units often have direct drive generators, direct current output, aero elastic blades, lifetime bearings and use a vane to point into the wind. The smaller wind turbine systems are designed for a small tower with a foundation at ground level or upon a roof top. Although less expensive to manufacture and entail less to install, and cost less to the consumer for purchase, such systems violate some local residential property codes and standards, needs an open area for constant winds, and adjacent property owners objection to the installation of such systems due to the potential of property value lost. Thus, to generate wind electricity within the urban inner city one must have a constant stream of wind, retain the aesthetics and viable relationships within the neighborhood, and cost reasonable for urban inner city consumers. For inner city usage large and small wind turbine systems suffer from a number of disadvantages:
(a) Both large and small Wind Turbine systems require an outdoor area free from obstruction. The area will need to be clear from trees, hillsides, and a like objects to prevent wind stream lost.
(b) For use of a large turbine system one needs unobstructed winds to operate efficiently, so trees within acres around wind turbines are often cleared. And each turbine needs access roads for ongoing maintenance and power transmission lines. The cost of tree clearance, installation, and maintenance are expensive. Most large wind turbine systems are funded by investors, due to the production and installation cost.
(c) In locations near or around a group of high-rise buildings, wind shear generates areas of intense turbulence, especially at street-level. The risks associated with mechanical or catastrophic failure have thus plagued urban inner city wind development in densely populated areas, rendering the costs of insuring urban wind systems prohibitive. Moreover, quantifying the amount of wind in urban areas has been difficult, as little is known about the actual wind resources of towns and cities because of the building construction dynamics.
(d) The tower wind turbines can be damaged in thunderstorms, partially because of their tall, thin shape. The National Lightning Safety Institute indicates that most damage to wind turbines is caused by lightening. This is more of a problem in warmer parts of the world, where they are frequent. Moreover, the blades of wind turbines can hit birds who attempt to fly between them.

### SUMMARY

In accordance with one embodiment a wind turbine with a series of blades moving about a generally vertical axis, the wind being funneled into working engagement with the blades for urban inner city use comprises the use of wind that is created by central air conditioning cooling and chiller units, an area of constant wind streams with no wind obstructions, without taking away from the natural and created surrounding aesthetics and functions.

### ADVANTAGES

Accordingly several advantages of one or more aspects are as follows: to provide wind generated energy that does not require ample amounts of space, that does not remove the aesthetics of its location, that is relatively inexpensive, that is not an obstruction within its environment, that can be easily manufactured and installed, that will provide consumer with an alternative energy for consumption, storage, and distribution, and that does not remove any natural elements within its designed environment for use.

### DRAWINGS—FIGURES

In drawings, related figures have the same number but different alphabetic suffixes.

FIG. 1A shows a top angle view of vertical and horizontal structural beams and structural support beams above building chiller unit with and without PMA's and blades in accordance with one embodiment.

FIG. 1B shows a side angle view of vertical and horizontal structural beams and horizontal structural support beam above building chiller unit without PMA's and blades in accordance with one embodiment.

FIG. 2A shows a side angle view of vertical and horizontal structural beams and horizontal structural support beam with PMA's and blades without building chiller unit in accordance with one embodiment.

FIG. 2B shows a side angle view of vertical and horizontal structural beams and horizontal structural support beam with PMA's and blades above building chiller unit in accordance with one embodiment.

FIG. 3 shows a top view of the horizontal and vertical structural beams bolt hole connections and PMA bolt hole in accordance with one embodiment.

FIG. 4A shows a topside view of vertical structural beam with bolt holes in accordance with one embodiment.

FIG. 4B shows top view of base plate welded to vertical structural beam with base plate bolt holes in accordance with one embodiment.

FIG. 4C shows side view of vertical structural beam with bolt holes in accordance with one embodiment.

FIG. 4D shows side back view of vertical structural beam with bolt holes in accordance with one embodiment.

FIG. 4E shows side back view of horizontal structural beam with bolt holes in accordance with one embodiment.

FIG. 4F shows topside view of horizontal structural beam with bolt holes in accordance with one embodiment.

FIG. 5A shows a side view of horizontal structural beam and bolt holes, without PMA and blades connected in accordance with one embodiment.

FIG. 5B shows a side view of horizontal structural beam and bolt holes, with PMA and blades connected in accordance with one embodiment.

FIG. 6A shows a side view of horizontal structural support beam with bolt holes in accordance with one embodiment.

FIG. 6B shows a topside view of horizontal structural support beam with bolt holes in accordance with one embodiment.

FIG. 6C shows a bottom side view of horizontal structural support beam with bolt holes in accordance with one embodiment.

FIG. 7A shows a topside view of alternative embodiment angle iron bars, horizontal flat bar with PMA bolt hole, and expanded metal sheet with flat hinges in accordance with one embodiment.

FIG. 7B shows an exposed front side view of alternative embodiment angle iron bars, horizontal flat bar with PMA and blade connected, expanded metal sheet with flat hinges, and flat bars with rounded hinges, above a/c central cooling unit in accordance with one embodiment.

FIG. 8A shows a top view of blades with hub connected in accordance with one embodiment.

FIG. 8B shows a bottom side view PMA in accordance with one embodiment.

FIG. 8C shows a side view of flat hinges with pin removed and with pin connected in accordance with one embodiment.

FIG. 8D shows a side view of rounded hinges with pin removed and with pin connected in accordance with one embodiment.

FIG. 8E shows a side view of expanded metal sheet in accordance with one embodiment.

FIG. 8F shows a topside and back side view of angle iron bars in accordance with one embodiment.

FIG. 8G shows a topside view of horizontal flat bar in accordance with one embodiment.

FIG. 8H shows a topside view of flat bars in accordance with one embodiment.

### DRAWINGS—REFERENCE NUMERALS

| | | | |
|---|---|---|---|
| 10 | Horizontal Structural beam | 12 | Vertical Structural beam |
| 14 | Base plates | 16 | Horizontal structural support |
| | | | beam |
| 18 | AC chiller unit | 20 | PMA |
| 22 | Blades | 24 | Horizontal structural bolt hole |
| 26 | Vertical structural bolt hole | 28 | PMA bolt holes |
| 30 | PMA Rotor hole | | |
| 34 | Base plate bolt holes | 36 | PMA Teflon nuts |
| 38 | Horizontal structural support | 40 | AC Cooling unit |
| | beam hole | | |
| 42 | AC fan shrouds | 44 | Flat Bars |
| 46 | Angle iron bars | 50 | Expanded metal sheets |
| 52 | Hinges (rounded) | 54 | Hinges (flat) |
| 56 | Horizontal flat bar | | |

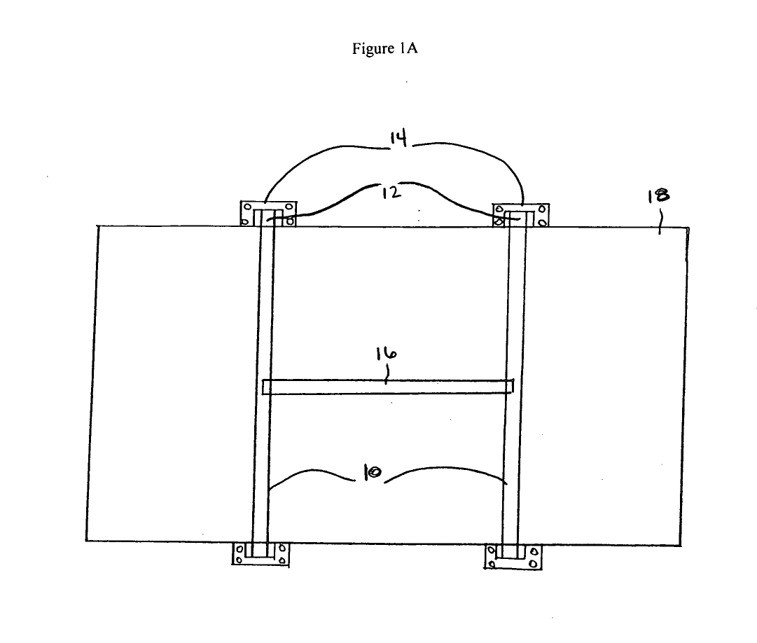

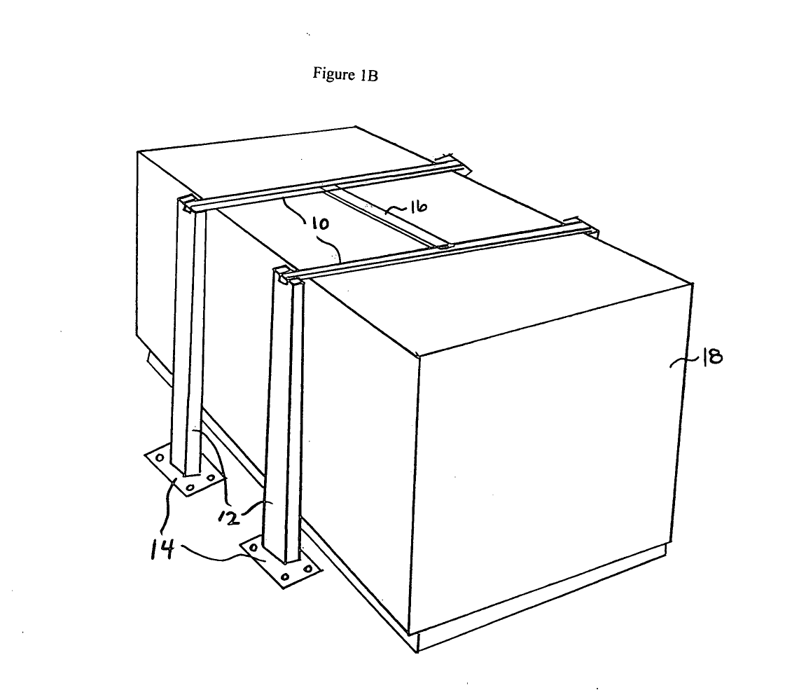

### DETAILED DESCRIPTION—FIRST EMBODIMENT—FIGS. 1-6

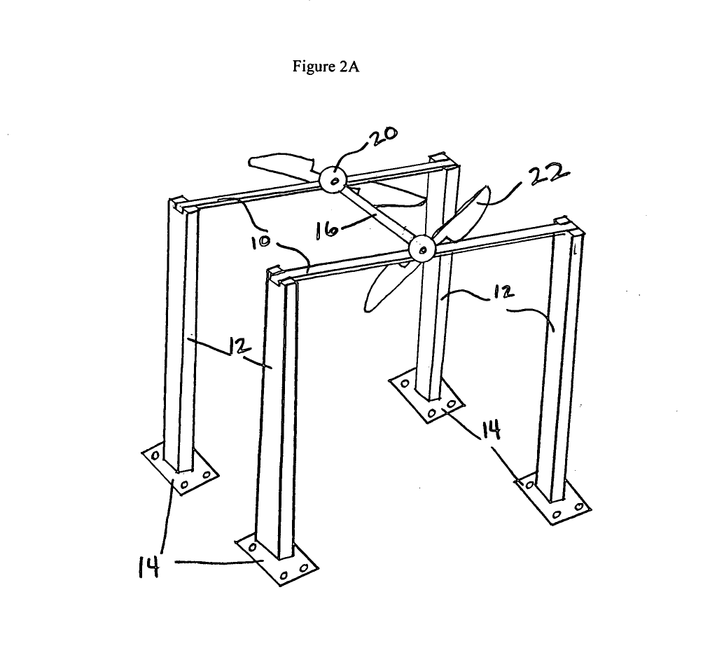

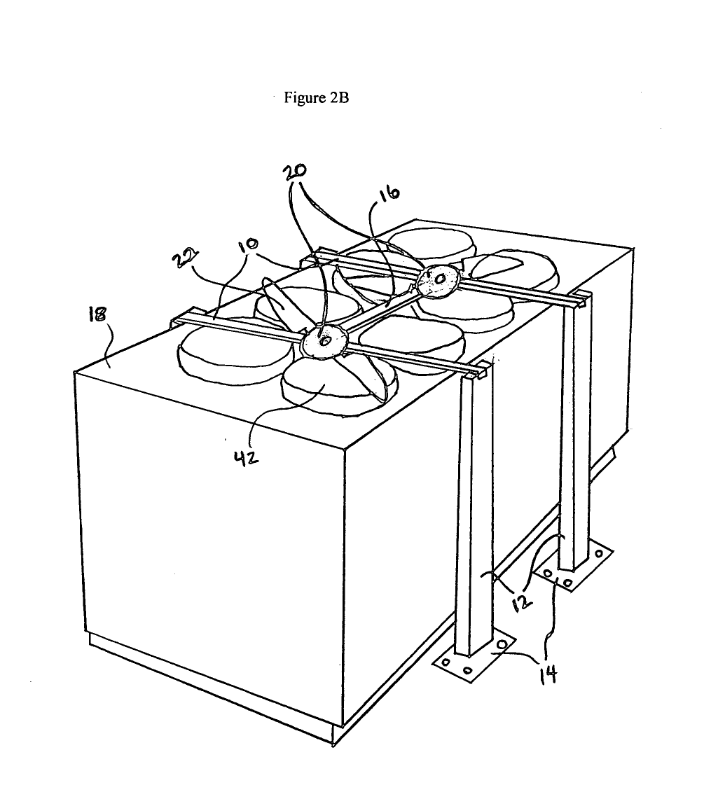

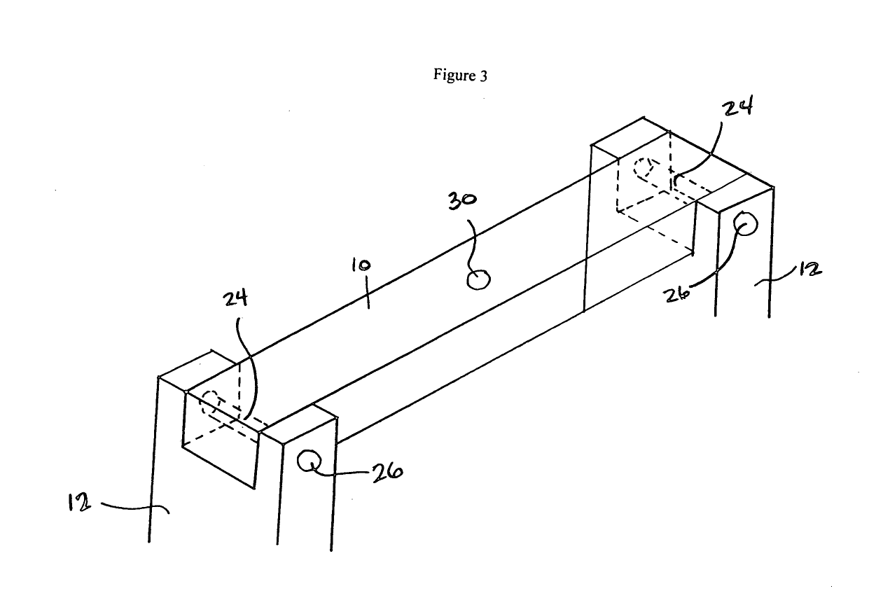

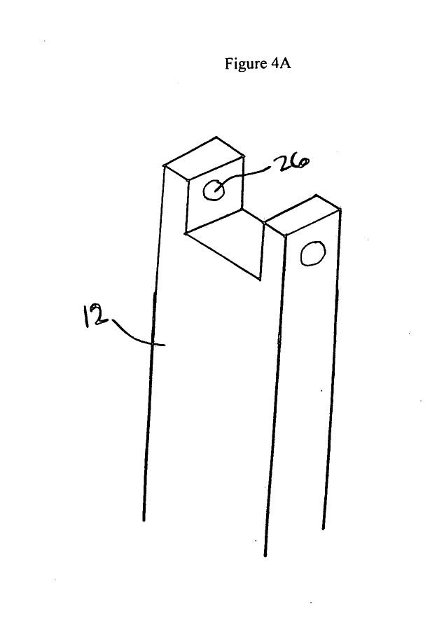

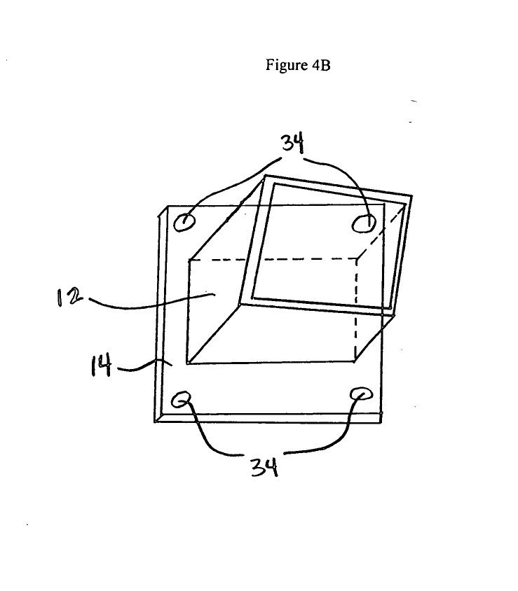

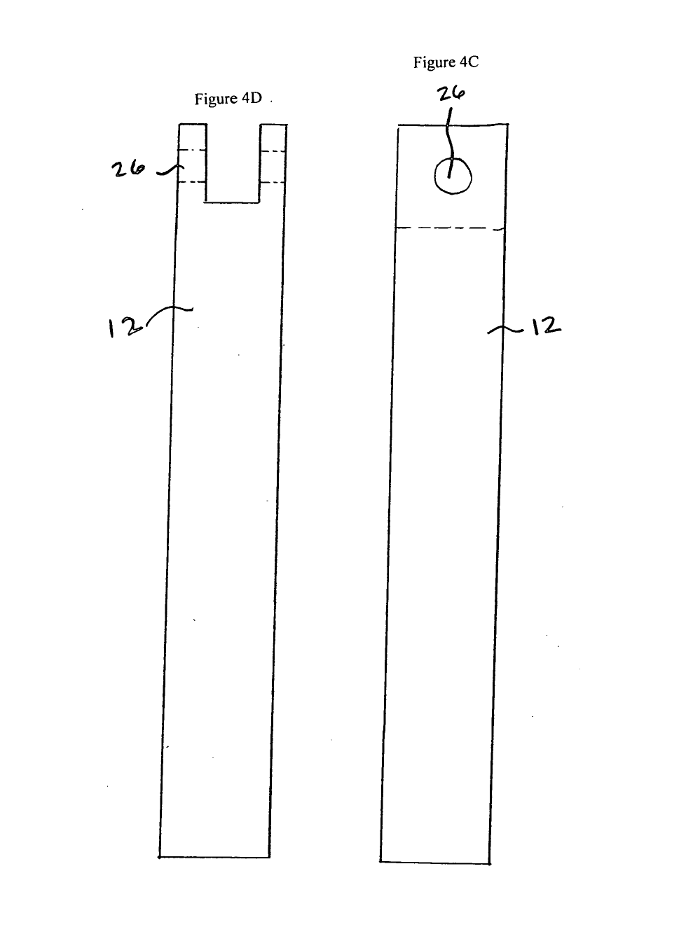

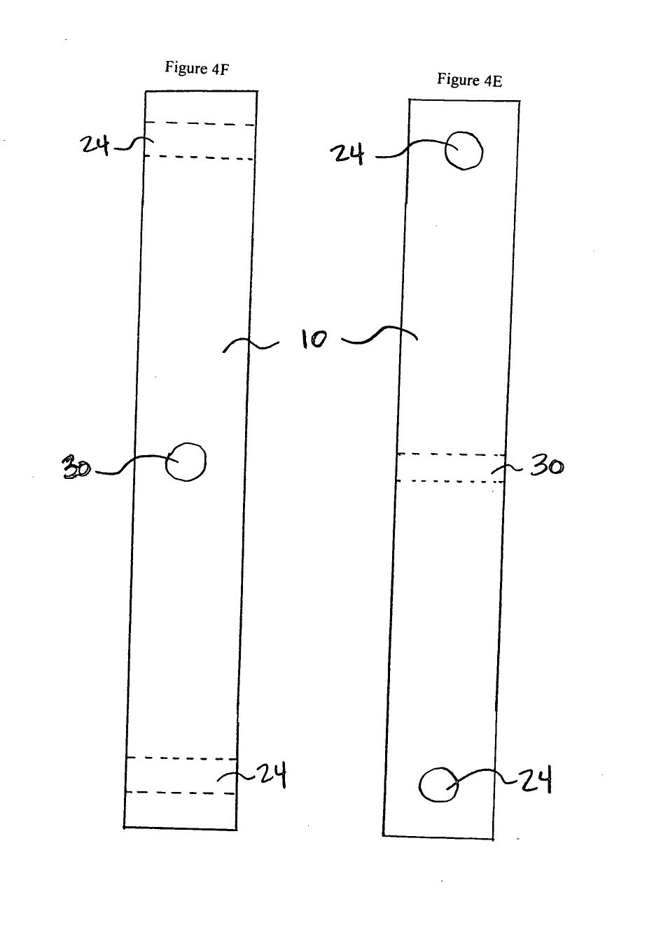

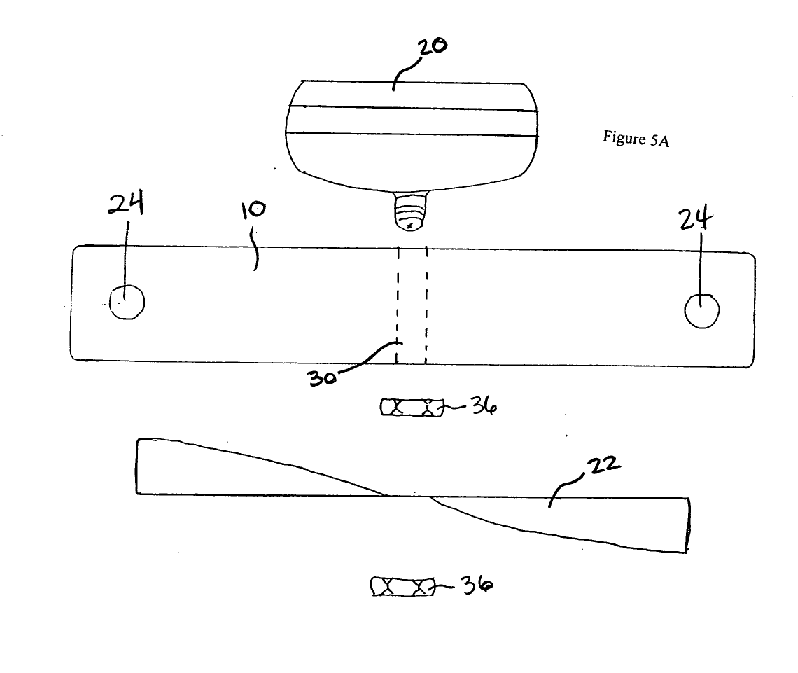

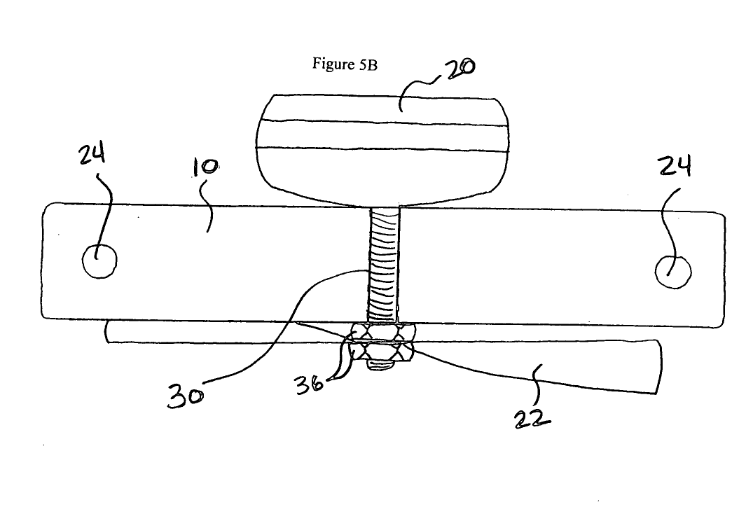

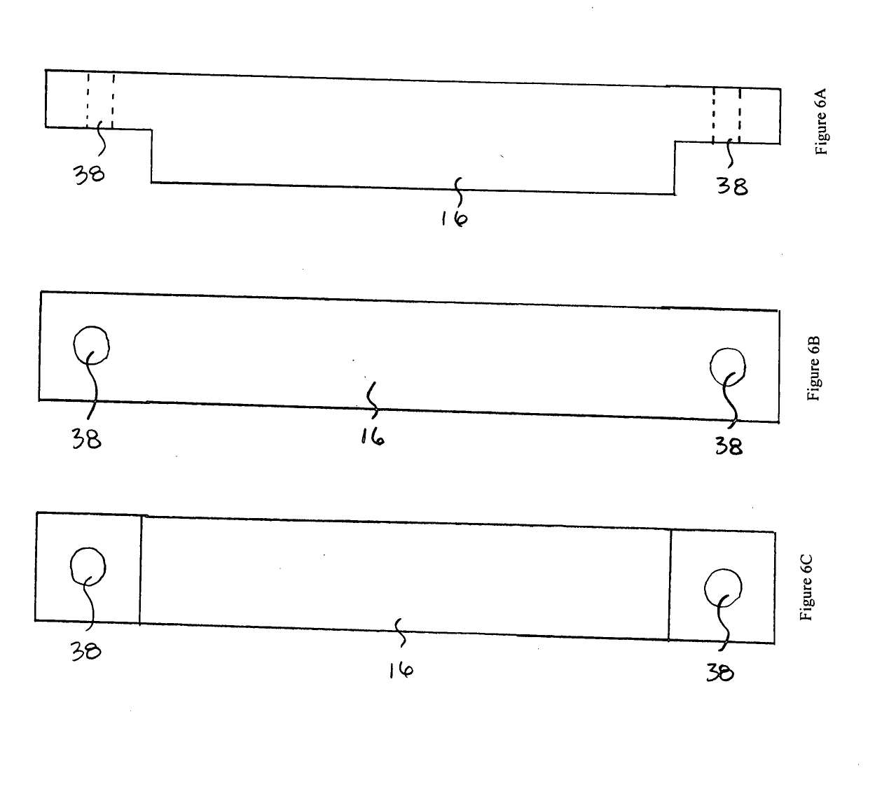

One embodiment of the closure is illustrated in FIG. 1A (top view), and 1B (end/side view), FIG. 2A and 2B (topside view of horizontal structural beam 10 and vertical structural beam 12 connected with PMA 20 and blades 22) 2B (topside view of horizontal structural beam 10 and vertical structural beam 12 connected with PMA 20 and blades 22 above chiller unit 18), FIG. 3 (topside view horizontal structural beam 10 and vertical structural beam 12 connected), FIG. 4A to 4F (detached zoomed in perspective views of horizontal structural beam 10 vertical structural beam 12 and base plate 14), FIG. 5A (detached zoomed in side view of horizontal structural beam 10 with PMA 20 and blades 22 not connected, and FIG. 5B (detached zoomed in side view of horizontal structural beam 10 and with PMA 20 and blades 22 connected), and FIG. 6A to 6C (detached zoomed in side, top, bottom view of horizontal structural support beam 16).

The embodiment has two horizontal structural beams 10 paralleling above chiller unit 18 with horizontal structural support beam 16 bolted through bolt holes 38 into horizontal structural beam 10 at center of horizontal structural beam 10. Horizontal structural beam 10 ends are bolted through bolt holes 24 and 26 onto four vertical structural beams 12 that are welded into metal base plates 14. Base plates 14 are bolted through bolt hole 34 into chiller unit 18 foundation surface. PMA 20 is bolted through bolt hole 30 into top side of horizontal structural beam 10 with blades 22 connected to rotor of PMA 20 fastened with nuts on the bottom side of horizontal structural beam 10.

The embodiment of one closure as shown in FIGS. 1 to 6 consists of steel structural tubing material. However, the structural tubing can consist of any other material that supports structural integrity, such as metal, wood, aluminum, harden plastic, etc. Blades 22 consist of aluminum and/or steel materials.

### OPERATION—FIRST EMBODIMENT—FIGS. 1-6

The manner of using the AC chiller unit 18 to generate a wind current, when the AC chiller unit 18 is on wind is generated outward from the chiller unit 18 fans. As shown in FIG. 2B, when chiller unit 18 generates wind, the blades 22 above chiller unit 18 spin turning the PMA 20 rotor generating electricity. When AC chiller unit 18 is off and is not generating a wind current, blades 22 will stop spinning which will stop the turning of PMA 20 rotor, pausing the generation of electricity. The electricity generated from PMA 20 when AC chiller unit 18 is on can be used to power buildings, stored for later/alternative use on site in a battery bank, and/or sent to the local energy providing company for credits or storage for later use.

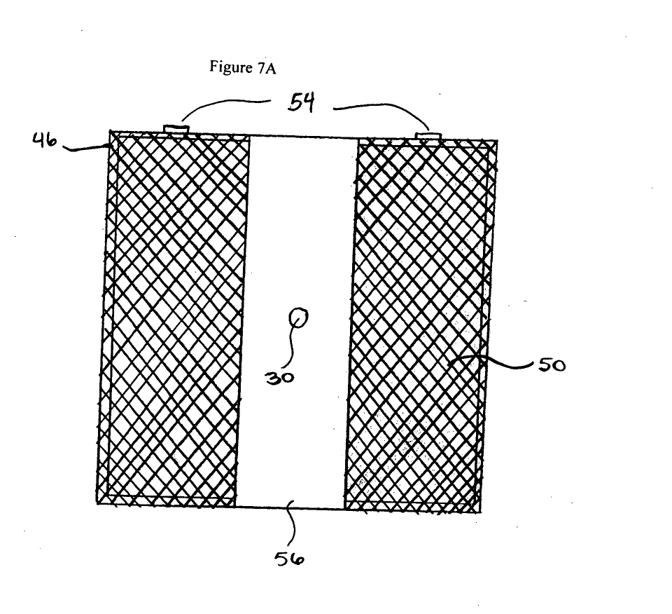

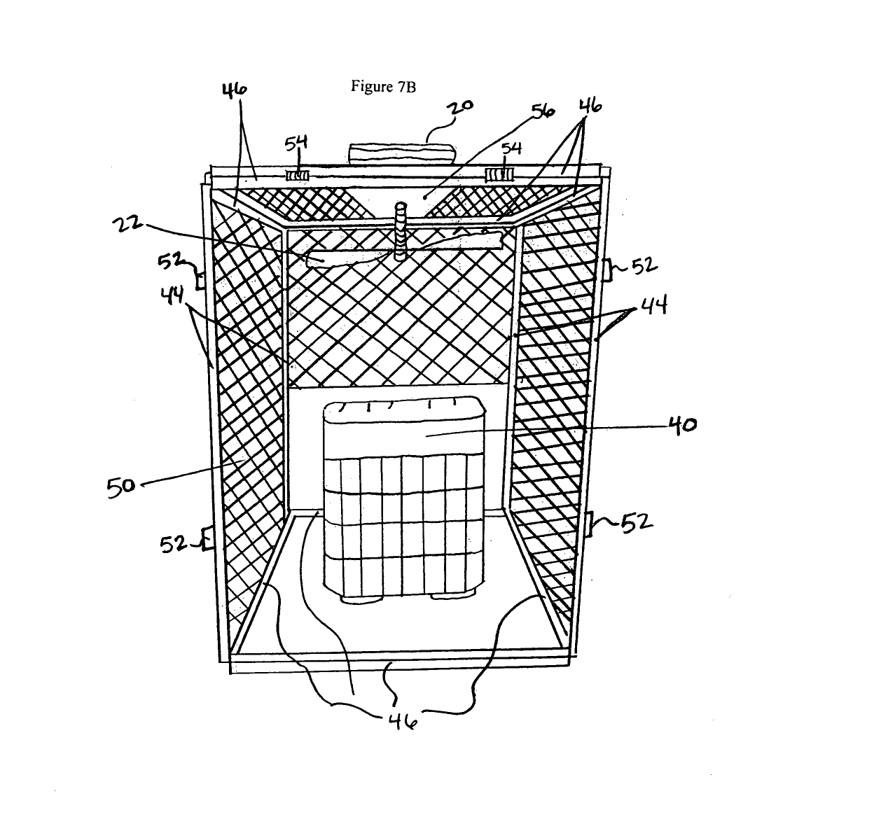

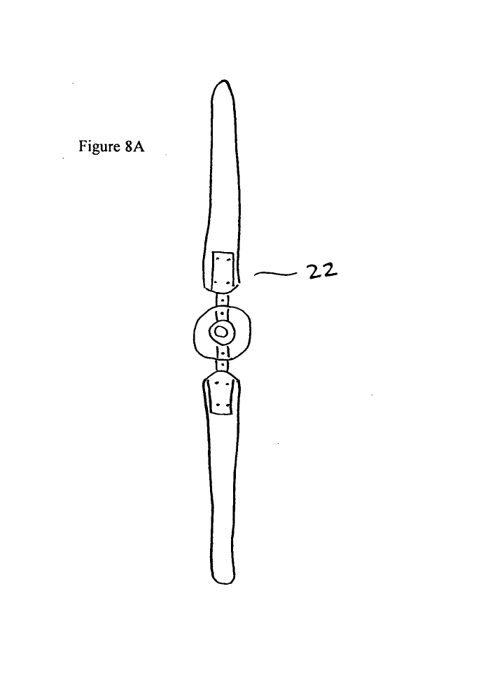

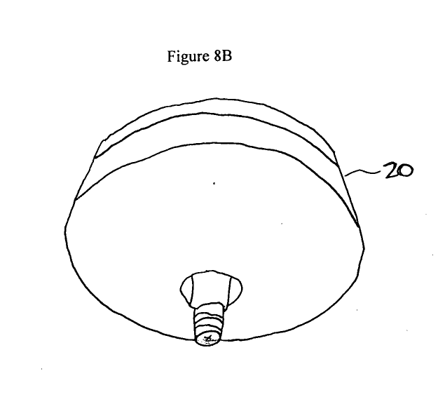

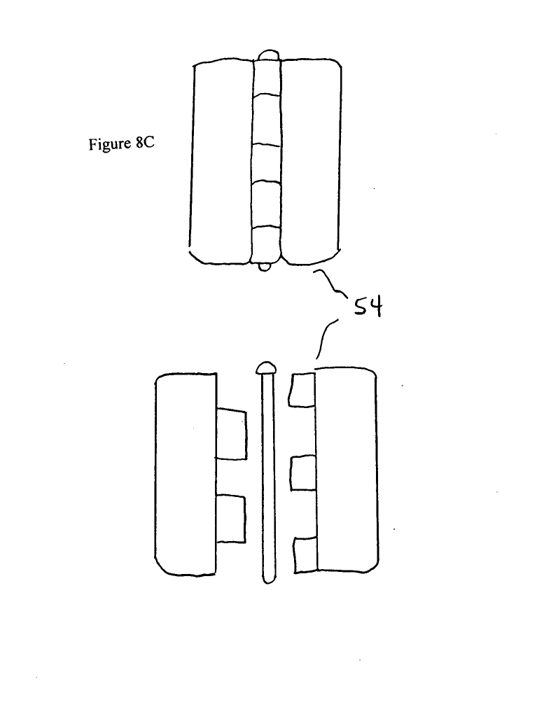

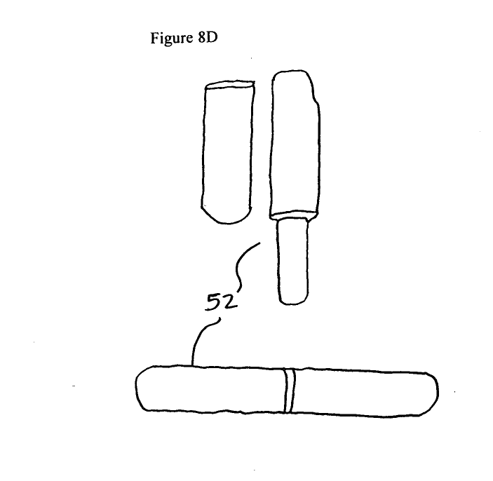

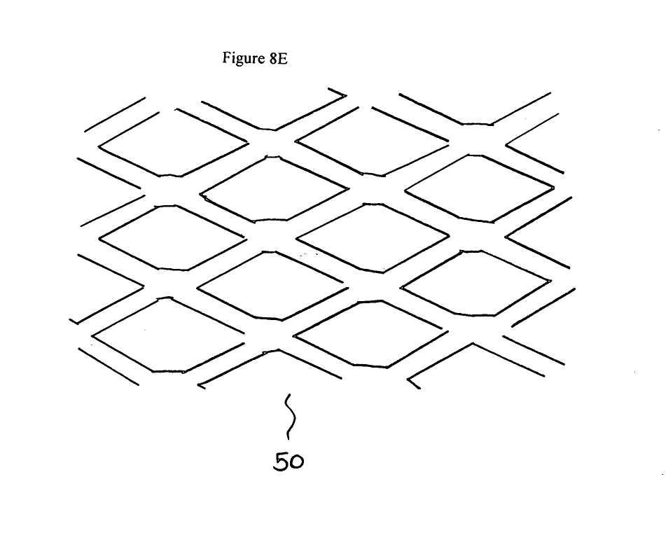

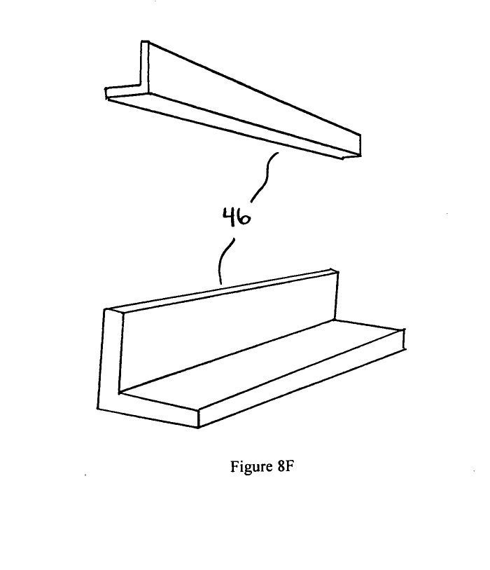

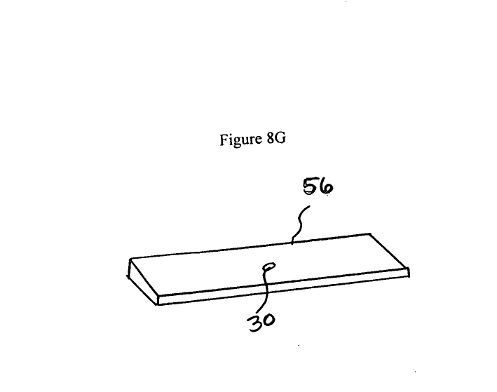

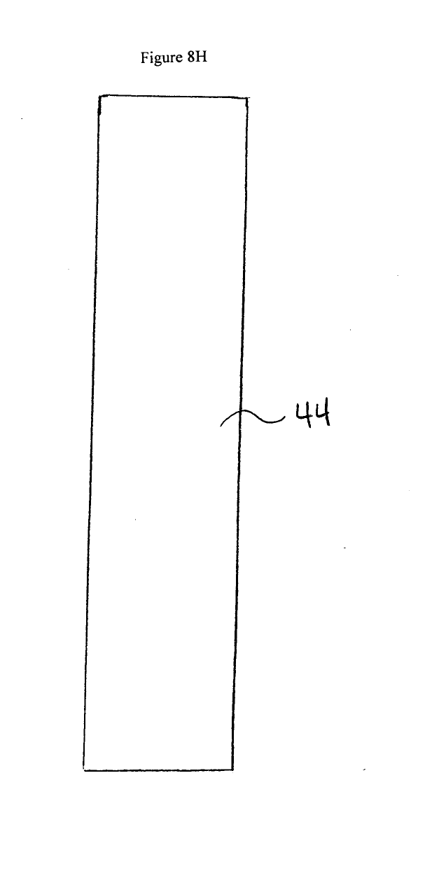

### DESCRIPTION—ALTERNATIVE EMBODIMENT—FIGS. 7-8

The embodiment of the closure in FIG. 7B (expose front side view) has two vertical flat bars 44 (FIG. 8H) that are welded onto two horizontal angle iron bars 46 (FIG. 8F) forming a vertical rectangle shape. Inside of the vertical rectangle shape, expanded metal sheet 50 (FIG. 8E) is welded between flat bars 44 and angle iron bars 46 forming a single side of the embodiment.

Hinges 52 (FIG. 8D) are welded onto the outsides of flat bars 44, at top and bottom of single side embodiment. Vertical rectangle shape embodiment with hinges 52 is formed four times. All four vertical rectangle shape embodiments are adjoined together with hinges 52, forming a closed square shape embodiment. Illustrated in FIG. 7A, expanded metal sheet 50 is welded to four angle iron bars 46 horizontally composing top of square shape embodiment, horizontal flat bar 56 is welded onto adjacent angle iron bars 46 of the top of square shape embodiment, centered paralleling above AC cooler unit 40. Illustrated in FIG. 7A, hinge 54 (FIG. 8C) is welded to the top for the square shape embodiment, and to the top of the square shape embodiment, connecting the top for the square shape embodiment to the square shape embodiment. FIGS. 7A and 7B, PMA 20 (FIG. 8B) rotor core arm sits inside of hole on flat bar 56. Blade 22 (FIG. 8A) is secured to PMA 20 rotor core arm with Teflon nuts beneath bottom side of flat bar 56.

The embodiment of one closure as shown in FIG. 7A to 7B consisting of steel structural material. However, the structural material can consist of any other material that supports structural integrity, such as metal, wood, aluminum, harden plastic, etc. Blades 22 consist of aluminum and/or steel materials.

### OPERATION—ALTERNATIVE EMBODIMENT—FIGS. 7-8

The manner of using the AC cooling unit 40 to generate a wind current, when the AC cooling unit 40 is on wind is generated outward from the AC cooling unit 40 fans. As shown in FIG. 7B, when cooling unit 40 generates wind, the blades 22 (FIG. 8A) above AC cooling unit 40 spin turning the PMA 20 (FIG. 8B) rotor generating electricity. When AC cooler unit 40 is off and is not generating a wind current, blades 22 will stop spinning which will stop the turning of generator 20 rotor, pausing the generation of electricity. The electricity generated from PMA 20 when AC cooler unit 40 is on can be used to power buildings, stored for later/alternative use on site in a battery bank, and/or sent to the local energy providing company for credits or storage for later use.

### Conclusion, Ramification, and Scope

Accordingly the reader will see that, according to the two embodiments of the wind turbine apparatus generating electricity from wind byproduct of AC chiller and cooling units, we have provided the wind turbine apparatus to provide wind generated energy that does not require ample amounts of space, that is relatively inexpensive, that is not an obstruction within its environment, that does not remove the aesthetics of its location, that can be easily manufactured and installed, that will provide consumer with an alternative energy for consumption, storage, and distribution, and that does not remove any natural elements within its designed environment for use.

While the above description contains much specificity, these should not be construed as limitations on the scope of any embodiment, but as exemplification of various embodiments thereof. Many other ramifications and variations are possible within the teachings of the various embodiments. For example horizontal structural beams 10 can be constructed as such it does not use the horizontal structural support beam 16 when above AC chiller unit 18. The horizontal structural beams 10 can be crossed supporting without a need for horizontal support beam 16.

Thus the scope should be determined by the appended claims and their legal equivalents, and not by the examples given.

We claim:

1. Wind turbine apparatus generating electrical power of the type comprising rotor blades (A) attached with nuts (B) onto electrical generator (C), bolted onto horizontal structural beams (D) paralleling above building AC chilling and cooling units (E), bolted onto vertical structural beams (F) that are grounded to the cooling and chilling foundation surface, using wind generated from the chiller and cooling units to rotate the said (A) attached to the said (C) creating electricity for production, consumption, and storage.
a. Said rotor blades (A) comprising of materials with characteristics of light in weight, durable, weather resistant, aerodynamically shaped based on lift and drag force
b. Said (1a) is bolted to said generator (C). Said (1a) and (C) are bolted together with said nut (B)
c. Said (1a-b) rotates from wind generated from building cooling and chilling units (E) generating electricity
d. Said (A), said (B), and said (C) as claimed in lines (1a-c), are bolted onto said horizontal structural beam (D), horizontally parallel to location on said (E) where wind is generated outward
e. Said (1d) is connected to vertical structural beams (F) that are grounded with base plates into the foundation surface with bolts
f. Said (F) are bolted into said (D) on both ends of said (D). Said (F) are bolted into the foundation surface, standing vertically erect paralleling standing sides of said (E), connecting said (D) to said (F)
g. Said (F) is connected to said (D) with bolts
h. Said (D) and said (F) comprising metal, aluminum, wood, etc
i. Said (A) comprising aluminum or metal
j. Said (B) comprising Teflon grooved and weather resistant technology

2. The said claim 1 wherein apparatus generating electrical power for production, consumption, and storage is powered by wind generated from building cooling units

3. The said claim 1 wherein said generator and blades are bolted onto horizontal structural beams that parallels above building AC chilling and cooling units
a. Said structural beams (D) are horizontally parallel above building AC chilling and cooling units
b. Said structural beams (D) are bolted from both ends into said structural rods (F)
c. Said structural beams (F) are bolted into the said (D) foundation surface, standing vertically erect with the vertically standing sides of said (D)
d. Said (F) has a flat base plate that is bolted into foundation surface of said (D) for easy disassembling for AC chiller and cooler unit maintenance/service
e. Said (F) base plate is welded onto said (F)

4. The said claim 2 wherein apparatus is powered by wind generated from building chilling and cooling units, creating electrical power for production, consumption, and storage
a. Said claim 4 power for production, electrical power is created and produced when wind from said (E) is rotating said apparatus
b. Said claim 4 power for, consumption, electrical power is created and produced when wind from said (E) is rotating said apparatus, this energy will be used to power the building and any other electrical uses
i. Said claim 4b, and other electrical uses comprising electrical energy for adjacent buildings, other buildings managed and/or owned by users/consumers
c. Said claim 4 power for, storage, storage of electrical power on the same site and location as the said (E), storage of electrical power at local energy company, and storage of electrical power for distribution
i. Said claim 4c, storage of electrical power on the same site and location as the said (E), Storage of electricity will be housed in an enclosure unit for protection from weather. Inside enclosure unit are housed battery system/s/to harness electrical power/energy for consumption and distribution

5. Alternative embodiment claim Wind turbine apparatus generating electrical power of the type comprising rotor blades (A) attached with nuts (B) onto electrical generator (C), bolted onto horizontal flat bar (G) paralleling above building AC chilling/cooling units (E), welded onto square shape cage of the type (F) that rest on the AC cooling/chilling foundation surface, using wind generated from the AC chiller/cooling units to rotate the said (A) attached to the said (C) creating electricity for production, consumption, and storage.
a. Said rotor blades (A) comprising of materials with characteristics of light in weight, durable, weather resistant, aerodynamically shaped based on lift and drag force
b. Said (5a) is bolted to said generator (C). Said (5a) and (C) are bolted together with said nut (B)
c. Said (5a-b) rotates from wind generated from building AC cooling/chilling units (E) generating electricity
d. Said (A), said (B), and said (C) as claimed in lines (5a-c), are bolted onto said horizontal flat bar (D), horizontally parallel to location on said (E) where wind is generated outward
e. Said (5d) is connected to square shape cage of the type (F) that rest on the AC cooling/chilling foundation surface
f. Said (F) is resting on the AC cooling/chilling unit foundation surface, standing vertically erect paralleling standing sides of said (E)
g. Said (D) is welded to said (F)
h. Said (D) and said (F) comprising metal, aluminum, wood, etc
i. Said (A) comprising aluminum or metal
j. Said (B) comprising Teflon grooved and weather resistant technology

6. The said claim 5 wherein apparatus generating electrical power for production, consumption, and storage is powered by wind generated from building AC chilling/cooling units

7. The said claim 5 wherein said generator and blades are bolted onto horizontal flat bar that parallels above building AC chilling/cooling units
a. Said horizontal flat bar (D) is horizontally parallel above building AC chilling/cooling units
b. Said horizontal flat bar (D) is welded from both ends into said square shape cage of the type (F)
c. Said square shape cage of the type (F) is standing vertically erect with the vertically standing sides of said (E)
d. Said (F) has hinges that is welded into the top surface of said (F) for easy disassembling for AC chilling/cooling unit maintenance/service
e. Said (F) has hinges connecting all sides of said (F) together, forming the said (F) square shape cage of type

8. The said claim 6 wherein apparatus is powered by wind generated from building chilling and cooling units, creating electrical power for production, consumption, and storage
a. Said claim 8 power for production, electrical power is created and produced when wind from said (E) is rotating said apparatus
b. Said claim 8 power for, consumption, electrical power is created and produced when wind from said (E) is rotating said apparatus, this energy will be used to power the building and any other electrical uses
i. Said claim 8b, and other electrical uses comprising electrical energy for adjacent buildings, other buildings managed and/or owned by users/consumers
c. Said claim 8 power for, storage, storage of electrical power on the same site and location as the said (E), storage of electrical power at local energy company, and storage of electrical power for distribution
i. Said claim 8c, storage of electrical power on the same site and location as the said (E), Storage of electricity will be housed in an enclosure unit for protection from weather. Inside enclosure unit are housed battery system/s/to harness electrical power/energy for consumption and distribution

9. Comprising said claims 1-8
